(19) United States
(12) Patent Application Publication
(10) Pub. No.: US 2009/0092159 A1
(43) Pub. Date: Apr. 9, 2009

(54) Semiconductor light-emitting device with tunable emission wavelength

(75) Inventor: Takashi Kato, Yokohama-shi (JP)

Correspondence Address: SMITH, GAMBRELL & RUSSELL, 1130 CONNECTICUT AVENUE, N.W., SUITE 1130, WASHINGTON, DC, 20036, US

(73) Assignee: SUMITOMO ELECTRIC INDUSTRIES, LTD.

(21) Appl. No.: 12/010,085

(22) Filed: Jan. 18, 2008

(30) Foreign Application Priority Data
May 28, 2007 (JP) 2007-140856
Aug. 29, 2007 (JP) 2007-223082

(51) Int. Cl. H01S 3/10

(52) U.S. Cl. 372/20

(57) ABSTRACT

The present invention is to provide a semiconductor light-emitting device with a variable output wavelength that reduces the wavelength dependence of the optical output power. The light-emitting device provides an optical cavity defined by a reflective end and a reflector. The gain waveguide and the ring resonator are set within the cavity. The reflector comprises a plurality of gratings each accompanied with an electrode. The periodicity of the refractive index in respective gratings is different from each other. The ring resonator shows a plurality of transmission maxima. The light-emitting device emits light with a wavelength defined by the transmission maxima of the ring resonator and the enhanced reflectivity region adjusted by the bias applied to electrodes of the optical reflector.

### BACKGROUND OF THE INVENTION

1. Field of the Invention

The present invention relates to a semiconductor light-emitting device.

2. Related Prior Art

Matsuo et al. disclosed a wavelength variable laser in IEEE International Semiconductor Laser Conference 2006 TuB2, titled by “Widely tunable laser using micro ring resonators.” This wavelength variable laser included two ring resonators. Specifically, the wavelength variable laser had two facets opposite to each other forming the laser resonator. In order to realize the wavelength variable function, the laser formed within the laser resonator two ring resonators with different radii to each other. Varying the current injected into these ring resonators, the refractive index thereof was changed, which resulted in the change of the resonant wavelength of the ring resonator.

Two ring resonators had a function of a wavelength variable filter. Each ring resonator inherently had a transmission spectrum with a period specific to the radius thereof; accordingly, two ring resonators collectively exhibited the higher transmittance when the wavelengths passable in each resonator became identical to the other. Thus, the ring resonators made it possible to select the peak wavelength of the transmittance drastically with a less current injected thereto. This phenomenon has been called as a vernier effect.

A United States Patent Application published as 2004-0125833A has disclosed a semiconductor device with a tunable wavelength in a wide range. This device provided a reflector comprising an active section, a ring resonator and a sampled grating (SG) reflector. The SG-reflector, which is a type of non-uniform grating, has a plurality of gratings each having a same period of the refractive index and arranged regularly. The reflection spectrum of the SG-reflector shows a plurality of peaks, the center of which is determined by the period of the refractive index, the span thereof is decided by the distance between the gratings, and the magnitude of respective peaks shows a convex envelope with a maximum coincide with the center peak. The emission wavelength of this semiconductor device is determined by the vernier effect between the periodic transmittance of the ring resonator and the periodic reflectance of the SG-reflector.

The tunable laser installing a plurality of ring resonator, such as disclosed by Matuso, may optically couple the ring resonator with the waveguide with an directional coupler or an MMI coupler (multi mode interference coupler). However, such coupler causes an optical loss by a few decibels (dB) per one coupling, which increases the threshold level for the laser operation and reduces the emission efficiency, namely the slope efficiency, of the laser device.

The semiconductor device disclosed in the Japanese Patent above provides the SG-grating to form the laser cavity instead of the ring resonator. One of the reflection peaks due to the SG-grating coincides with one of the transmission peaks of the ring resonator. The reflection spectrum of the SG-grating includes many reflection peaks with the specific wavelength period and the maximum of each reflection peak decreases as the peak wavelength is apart from the center wavelength. The emission intensity of the laser oscillation strongly depends on the maximum of each reflection peak. Moreover, the decrease of the maximum reflectance of respective peaks of the SG-grating is relatively large, which restricts the available wavelength range for the laser oscillation.

Moreover, the tunable laser using the vernier effect substantially has a subject that each reflectance peak of the SG-grating and each transmission peak of the ring resonator shows a narrower width and the superposition of these two spectrum is inherently unstable, that is, a slight change of the reflection spectrum or that of the transmission spectrum causes a large variation in the emission wavelength.

The present invention, motivated with the subjects above, is to provide a semiconductor light-emitting device whose optical output power shows less dependence on the emission wavelength.

### SUMMARY OF THE INVENTION

One aspect of the present invention concerns a semiconductor light-emitting device capable of tuning an emission wavelength. The light-emitting device comprises; (a) an optical cavity defined by a reflective end and an optical reflector, (b) a gain waveguide provided within the optical cavity and having an optical gain by injecting carriers, and (c) a ring resonator provided within the optical cavity.

The optical reflector includes an optical grating with a plurality of electrodes and shows a variable reflection spectrum with single peak by applying bias voltages to specific electrodes among the plurality of electrodes to change a refractive index of a portion of the optical grating covered by the specific electrodes. The ring resonator has a transmission spectrum with a plurality of transmission maxima.

According to the configuration above, applying the bias voltages to the electrodes of the optical reflector, a composite reflection spectrum of the optical reflector shows single peak. Therefore, the emission wavelength of the light-emitting device may be determined by overlapping the transmission maxima in the transmission spectrum of the ring resonator with the single peak in the reflection spectrum of the optical reflector without using the vernier effect.

The optical grating in the optical reflector of the present invention may include a plurality of grating sections. Each section has a specific period of the refractive index. One of the electrodes may correspond to one of the grating sections. The specific period of the refractive index of respective grating sections may monotonically change from an end of the optical grating to another end of the optical grating.

In another feature of the present invention, the optical grating may be a chirped grating with periods of the refractive index linearly increasing from an end of the optical grating to the other end thereof. The specific electrodes may change the refractive index of a portion of the chirped grating covered by the specific electrodes and the composite reflection spectrum of the optical reflector shows the single peak. Thus, the light-emitting device may select one of the transmission maxima in the transmission spectrum of the ring resonator by the optical grating of the optical reflector without using the vernier effect. Because the reflection peak in the composite spectrum of the optical reflector shows relatively wide width, thus selected emission wavelength of the light-emitting device may be stable during the operation of the device.

Moreover, the optical reflector of the present invention may adjust not only the wavelength of the reflection maximum but also the maximum reflectivity by adjusting the bias voltages applied to the specific electrodes of the optical grating.

The composite reflection spectrum of the optical reflector include at least one of the transmission maxima in the transmission spectrum of the ring resonator. Setting the transmission maxima in the transmission spectrum of the ring resonator within the broad wavelength range enhanced in the reflectivity thereof as those described above, the longitudinal mode of the optical output from the light-emitting device may be stabilized.

The light-emitting device of the invention may further provide an optical phase adjuster with an electrode in the optical cavity. Applying a bias voltage to the electrode, the phase adjuster may change the refractive index in the phase adjuster covered by the electrode, which may also adjust the phase of the light resonated by the optical cavity even when the wavelength of the light may be tuned by the optical reflector and the ring resonator.

The light-emitting device of the invention may further provide an optical functioning device outside of the optical cavity. The optical functional device may be an optical modulator or an optical amplifier with an amplified wavelength band wider that covers the reflection spectrum of the optical reflector. The light-emitting device of the invention may integrally form the optical functioning device on single semiconductor substrate. The gain waveguide, the ring resonator, and the optical reflector may be also integrally formed on the single substrate.

The light-emitting device of the invention may form the ring resonator on a silica substrate, while, the gain waveguide and the optical reflector may be formed on the semiconductor substrate. The waveguide formed on the silica substrate may directly couple with the gain waveguide on the semiconductor substrate by a butt-joint technique or indirectly couple therewith by an optical lens.

### BRIEF DESCRIPTION OF DRAWINGS

FIG. 1 shows a semiconductor light-emitting device according to an embodiment of the present invention;

FIG. 2A is a reflection spectrum of the optical reflector without any bias voltage applied to electrodes and FIG. 2B is a composite reflection spectrum of the optical reflector with the bias voltage applied to one of electrodes;

FIG. 3A shows a transmitting spectrum of the ring resonator installed in the semiconductor light-emitting device of the present embodiment and FIG. 3B describes a mechanism to select a wavelength of the laser emitting in the light-emitting device of the present embodiment;

FIG. 4 shows an optical output characteristic of the light-emitting device of the present embodiment;

FIG. 5 schematically shows a modified semiconductor light-emitting device of the present embodiment;

FIG. 6 schematically shows a still modified semiconductor light-emitting device of the present embodiment;

FIG. 7 schematically shows a cross section of the light-emitting device of the present embodiment, which is taken along the line II-II in FIG. 6;

FIG. 8 schematically shows still another modification of the semiconductor light-emitting device of the present embodiment;

FIG. 9 shows an optical gain in the gain-coupled waveguide;

FIG. 10 schematically shows a light source that includes a semiconductor light-emitting device with a wavelength variable function of the present embodiment:

FIG. 11 schematically shows a semiconductor light-emitting device according to the second embodiment of the invention;

FIG. 12 is a reflection spectrum of the optical reflector installed in the light-emitting device of the second embodiment;

FIG. 13A shows a relation between the chirped grating and electrodes each covering a portion of the chirped grating, and FIG. 13B shows a relation between another type of chirped grating and electrodes; and

FIG. 14 schematically illustrates a light-emitting device with a hybrid configuration where the ring resonator is formed on a silica substrate, while, the gain waveguide and the optical reflector are formed on a semiconductor substrate.

### DESCRIPTION OF PREFERRED EMBODIMENTS

Next, preferred embodiments of the present invention will be described as referring to accompanying drawings. In the description of the drawings, the same symbols or numerals will refer to the same elements without overlapping explanations.

### First Embodiment

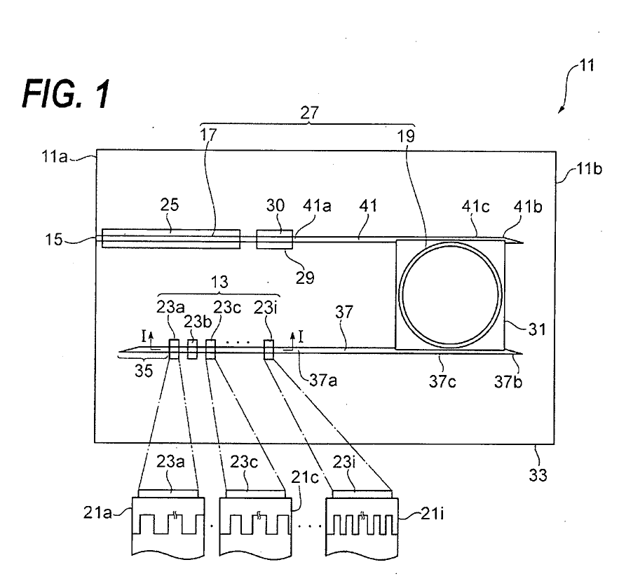

FIG. 1 schematically illustrates a semiconductor light-emitting device 11 according to an embodiment of the present invention. A feature of the present device is that the output wavelength emitted therefrom may be tunable. The device 11 includes an optical reflector 13, a reflective end 15, a gain waveguide 17, and a ring resonator 19. These elements are formed on a semiconductor substrate.

The optical reflector 13 includes a plurality of diffraction gratings, 21a, 21c and 21i, each having independent electrodes, 23a to 23c and 23i. FIG. 1 includes magnified views of respective gratings, 21a, 21c and 21i, each taken along the line I-I. The period of the gratings, 21a, 21c and 21i, are different from each other. The electrodes, 23a, 23c and 23i, are accompanied with respective gratings, 21a, 21c and 21i.

One end surface 11a of the semiconductor substrate forms the reflective end 15. The gain waveguide 17 has an optical gain due to the carrier injection from the electrode 25. The ring resonator 19 shows a transmittance with a plurality of peaks. The optical reflector 13 and the reflective end 15 operate as reflectors for the optical cavity of the semiconductor device 11, while, the ring resonator 19 and the gain waveguide 17 operate as the light source 27, where the ring resonator 19 and the gain waveguide 17 are arranged in serial to each other within the optical cavity.

Applying bias to the electrode, 23a, 23b, 23c and 23i, which modifies the composite reflection spectrum including reflection spectra of respective gratings, 23a to 23c and 23i, only one of the transmission maximum of the ring resonator 19 may be selected from a plurality of the transmission maximum without using the vernier effect, the mechanism of which will be explained later. Moreover, the optical reflector 13 does not use any sampled grating; accordingly, the unevenness of the peak magnitude in the reflection spectrum may not appear.

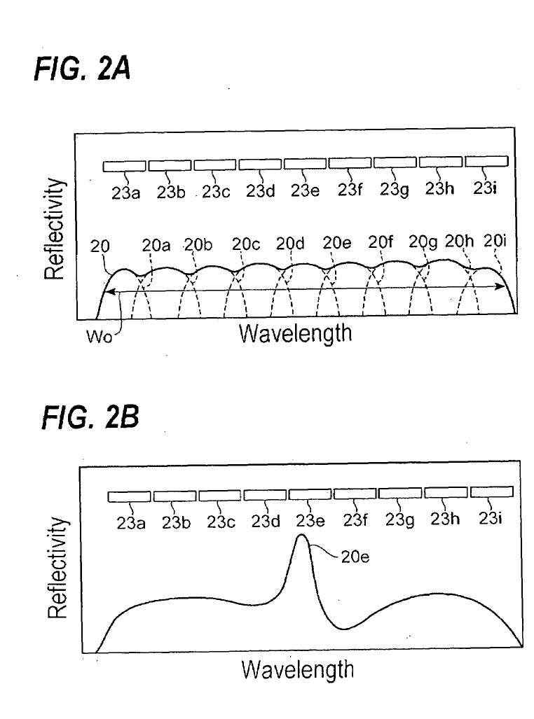

FIG. 2A shows an example of the composite reflection spectrum of the optical reflector 13. This reflector 13 provides nine gratings, 21a to 21i, arranged along the optical waveguide and nine electrodes, 23a to 23i, each corresponding to one of the gratings. Each grating, 21a to 21i, is a uniform grating where the grating shows single diffraction wavelength within a predetermined wavelength range. A composite reflectivity illustrated in FIG. 2A shows a reflection bandwidth of W_{O}. In the present embodiment shown in FIG. 2A, the reflection spectrum by one grating, for instance the grating 20e, may be enhanced in response to the electrical bias applied to the electrode 23e accompanied with this grating 20e. The magnitude of the reflection maximum is strengthened compared with the reflection maxima of the other gratings, 20a to 20d and 20f to 20i, where no bias is applied to those electrodes, 23a to 23d and 23f to 23i. As illustrated in FIG. 2B, the present device may modify the wavelength where the reflectivity becomes the maximum and/or may modify the absolute magnitude in the reflectivity.

Next, mechanisms to modify the reflectivity and the wavelength where the reflectivity becomes the maximum will be described. The diffraction wavelength λg(0) of the grating, where the diffraction is assumed to be the first order diffraction, may be denoted as;

λ_{g}(0)=2×n₀×Λ,

where n₀ is the refractive index of the medium and Λ is the period of the refractivity in the grating. Injecting the current into the grating, the refractive index n₀ decreases due to the plasma effect caused by the increase of the free carrier concentration, which causes the blue-shift of the diffraction wavelength. The shifted wavelength is given by;

λ_{g}(INJ)=2×n_{INJ}×ζ,

where n_{INJ} is the refractive index lowered by the free carrier injection. In order to increase the reflectivity at the target wavelength λ_{LD}, it is necessary to select the diffraction wavelength λ_{g}(0) that satisfies a condition λ_{g}(0)>λ_{LD}. Injecting the current into the grating whose diffraction wavelength λ_{g}(0) is longer than the target wavelength λ_{LD}, the diffraction wavelength λ_{g}(INJ) becomes close to the target wavelength λ_{LD} to increase the reflectivity around the target wavelength.

Describing the mechanism specifically as referring to FIGS. 2A and 2B. To increase the reflectivity at the wavelength corresponding to the grating 20e, it is necessary to inject current into the electrode 23f, which corresponds to the grating 20f, not the electrode 23e. The blue-shift of the diffraction wavelength of the grating 20f makes the reflectivity maximum of the grating 20f close to the reflectivity of the grating 20e. The composite reflectivity shows a large peak by adding the reflectivity of the grating 20f and that of the grating 20e. Thus, the reflectivity of one grating 20e with the specific diffraction wavelength λ_{g} among the gratings, 20a to 20i, may be strengthened compared to the reflectivity maxima of the other gratings, 20a to 20d and 20f to 20i, responding to the electrical bias applied to the electrode 23f whose accompanied grating 20f has the diffraction wavelength greater than the preset wavelength λ_{g}.

Thus, applying the electrical bias to the specific electrode corresponding to the grating whose diffraction wavelength around the predetermined oscillation wavelength and having the diffraction wavelength close to the predetermined oscillation wavelength, the reflectivity at the oscillation wavelength may be strengthened by the superposition of the reflection spectra of the gratings.

Moreover, the optical device 11 may further provide a phase adjuster 29, as shown in FIG. 1. The phase adjuster 29 includes an electrode 30 to apply the electrical bias to the optical waveguide between the reflectors of the optical cavity in order to adjust the phase. The optical device 11 according to the embodiment may vary the output wavelength by selecting one of the electrodes accompanied with the gratings, while, the phase of the light traveling in the laser cavity between the reflective end 15 and the selected grating. The phase adjuster 29 in the laser cavity may compensate this phase variation.

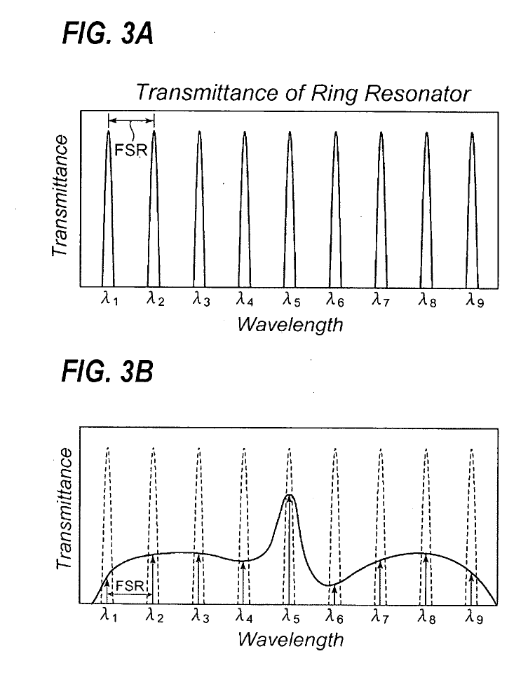

Next, a function of the ring resonator 19 of the present embodiment will be explained. FIG. 3A is an exemplary transmission spectrum of the ring resonator 19. The waveguide of the ring resonator 19 configures a closed loop, a diameter of which is, for instance, 10 to 1100 μm, and may be formed by the ordinal photolithography. The transmittance of the ring resonator 19 shows a plurality of peaks whose interval is determined by the free spectral range (FSR) of the optical path length of the resonator 19, which depends on the circumference of the ring. The peak wavelength is adjustable by applying an electrical bias to the electrode 31 formed on the waveguide of the resonator 19 to vary the refractive index of the substance of the resonator 19. The bias may be a voltage bias or a current bias.

The light generated in the gain waveguide 17 propagates backward and forward within the cavity as being filtered by the transmission spectrum of the ring resonator 19. FIG. 3B overlaps the transmission spectrum of the ring resonator 19 with the reflection spectrum of the optical reflector 13, which shows a relation of the wavelength grids with respect to the transmission spectrum to select one of the wavelength grids. The light-emitting device 11 may oscillate at one of wavelength grids, λ₁˜λ₉, shown in FIG. 3B. The ring resonator 19 in the FSR thereof decides these wavelength grids. The application of the bias to one of the electrodes, 23a to 23i, of the optical reflector 13 may select one of these grids, λ₁˜λ₉. Thus, the light-emitting device 11 may emit the laser light with the wavelength λ₅ where the peak wavelength of the reflectivity of the optical reflector 13 becomes the maximum depending on the application of the electrical bias to the electrodes, 23a˜23i.

As clearly shown in FIG. 3B, the light-emitting device of the present embodiment does not use the vernier effect in which the laser oscillation may be obtained at the wavelength where one of narrow reflection peaks overlap with one of narrow transmission peaks. While, in the light-emitting device of the present embodiment, the laser emission may occur at a wavelength where one of narrow transmission peaks overlaps with a relatively broad reflection peak but the spectral width thereof is preferably narrower than the FSR of the transmission peaks.

The one end of the optical reflector 13 optically couples with the light source 27, while the other end thereof provides a surplus waveguide 35 where the width of the waveguide becomes narrower to terminate the waveguide. This surplus waveguide 35 may optically couple with an external optical device.

The light-emitting device 11 integrates the elements described above, namely, the optical reflector 13, the reflective end 15, the gain waveguide 17, the ring resonator 19 and the phase adjuster 29, and they are formed on single substrate 33. Ordinal techniques of the semiconductor process, such as a crystal growth, an etching, an electrode formation and so on, may be applicable to form those elements mentioned above. Referring to FIG. 1 again, the detail of the light-emitting device 11 will be described. The light-emitting device 11 may further provide the first and second waveguides, 37 and 41. The first waveguide 37 optically couples the ring resonator 31 with one end of the optical reflector 13 and includes one end 37a coupled with the optical reflector 13, the other end 37b and an optically coupling portion 37c optically couples with the ring resonator 31 formed between the ends, 37a and 37b. The tip of the other end 37b is apart from the edge 11b of the light-emitting device 11.

The second waveguide 41 optically couples one of the ring resonator 19 and the gain waveguide 17 with the other. The second waveguide 41 includes one end 41a optically coupled with the gain waveguide 17 via the phase adjuster 29, the other end 41b and a coupling portion 41c formed between the ends, 41a and 41b, and optically coupled with the ring resonator 19. Because the backward light reflected at the boundary of the waveguide causes an optical noise within the cavity, which degrades the stable operation in the tuning of the emission wavelength, the ends, 37b and 41b, of the waveguides, 37 and 41, respectively, may leave substantially no reflection as possible. The ends, 37b and 41b, of the first and second waveguides, 37 and 41, gradually narrow the width thereof to terminate the waveguides. A narrowed termination may radiate the light outward. A bent waveguide is another type of the termination of the waveguide by which the backward reflection at the end of the waveguide may be substantially disappeared. Some absorbing materials or layers attached to the end of the waveguide may also realize the termination of the waveguide without any substantial reflection.

The light-emitting device 11 provides only two optical coupling portions, 37c and 41c, within the cavity. Therefore, the light-emitting device 11 shows less optical coupling loss compared to a conventional device providing two ring resonators, which includes four coupling portions. The narrowed termination of the waveguide may reduce the backward reflection at the end of the waveguide.

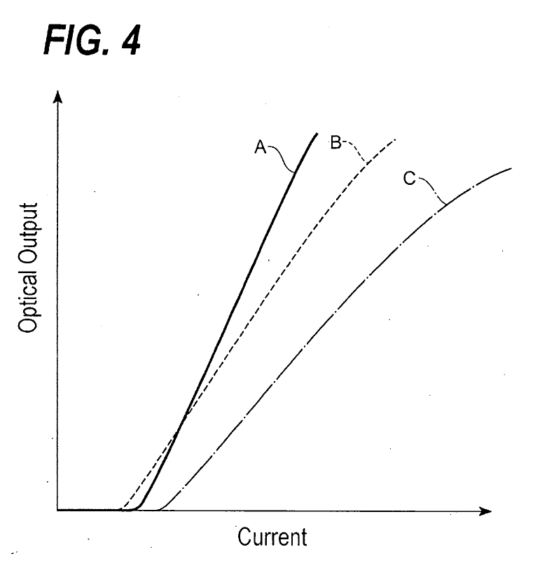

FIG. 4 shows an optical output characteristic of the light-emitting device 11 according to the present embodiment by a behavior A. The horizontal axis corresponds to the current applied thereto, while, the vertical axis denotes the optical output power obtained by the injection of the current. FIG. 4 also shows a behavior B of the conventional wavelength tunable laser using the SG-grating and a behavior C of the conventional wavelength tunable laser providing two ring resonators. Comparing the present device A with the conventional one C, because the light-emitting device 11 of the present invention provides single ring resonator, the device 11 of the invention shows a smaller threshold current because of the less optical coupling loss within the cavity and a better slope efficiency. Moreover, the output of the present device is taken from the reflective end 15, which enables to obtain a larger optical output.

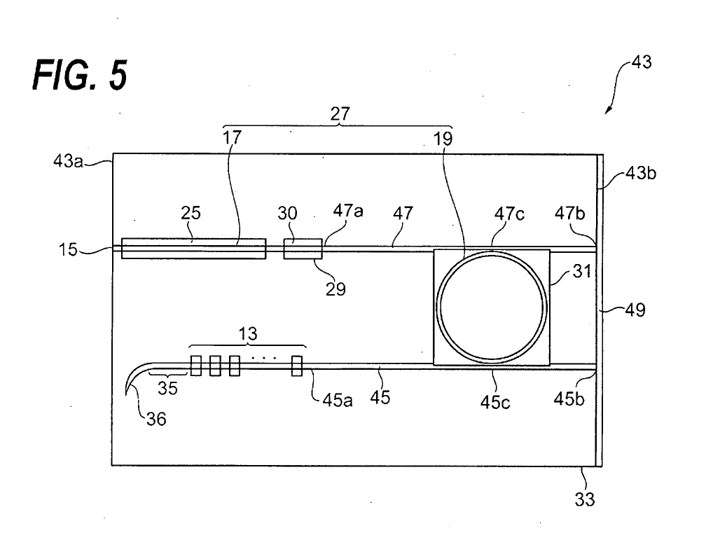

FIG. 5 schematically illustrates one modification of the light-emitting device shown in FIG. 1. The modified light-emitting device 43 includes first and second waveguides, 45 and 47. The first waveguides 45 optically couples one of the ring resonator 31 and the optical reflector 13 with the other. The second waveguide 47 optically couples one of the ring resonator 19 and the gain waveguide 17 with the other. One end of the optical reflector 13 provides a surplus portion 35 that is terminated by bending the tip 36 thereof. The first waveguide 45 includes one end 45a, the other end 45b and the coupling portion 45c between the ends, 45a and 45b. The first end 45a optically couples with the optical reflector 13 and the other end 45b extends to the end 43b opposite to the end 43a where the reflective end 15 of the gain waveguide is formed. The coupling portion 45c, formed between two ends, 45a and 45b, optically couples with the ring resonator 31. The second waveguide 47 also provides two ends, 47a and 47b, and the coupling portion 47c formed between the ends, 47a and 47b. The end 47a optically couples with the phase adjuster 29, while, the other end 47b extends to the end 43b. The coupling portion 47c optically couples with the ring resonator 19. The end 43b provides an anti-reflection (AR) coating 49.

The light-emitting device 43 provides only two coupling portions, 45a and 47c, within the cavity, therefore, the device 43 shows less optical coupling loss compared to the conventional device that provides two ring resonators. The AR coating 49 on the end 43b may reduce the backward reflection in the waveguides.

In another modification, the ends, 45b and 47b, may be bent at the end 43b in addition to the AR coating 49 to further reduce the backward reflection.

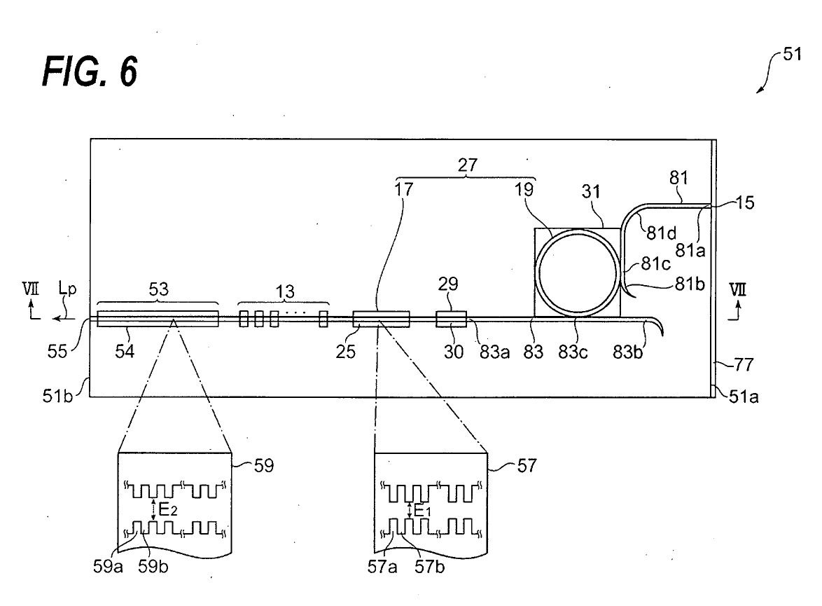

FIG. 6 schematically illustrates still another modification of the light-emitting device shown in FIG. 1. The light-emitting device 51 includes an optical functional device 53 and a light-emitting end 55. The optical functional device 53, which is optically coupled with the optical reflector 13 at the outside of the laser cavity, processes the light incoming from the optical reflector 13. The optical functioning device 53 includes an electrode 54 that receives an electrical signal to activate the functioning device 53. One example of the functioning device 53 is an optical modulator to modulate the light output from the optical reflector 13. The gain waveguide 17 may include an active layer with a multi-quantum well (MQW) structure 57. The MQW structure 57 includes a plurality of well layers 57a and a plurality of barrier layers 57b alternately stacked to each other. The well layer 57a has the band gap energy of E₁. The optical modulator 53 may be a type of the electro-absorption modulator (EA modulator) that includes an absorption layer 59 comprising the MQW structure with well layers 59a and barrier layers 59b. The well layer 59a in the EA modulator 59 has the band gap energy greater than the band gap energy E₁ of the active layer in the gain waveguide 17. Although the EA-modulator is exemplarily explained, the modulator is not restricted to the EA-modulator. Other types of the modulator, such as a Mach-Zender modulator, may be applicable to the light-emitting device 51.

In the light-emitting device 51, the functioning device 53 modulates the light output from the light source, 13, 15, 27 and 29, and the modulated light L_{P} may be emitted from the end surface 55.

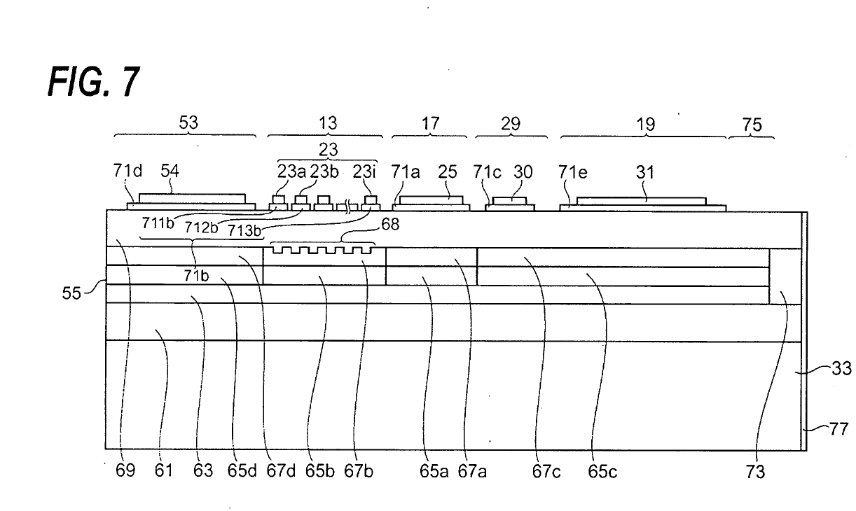

FIG. 7 is a vertical cross sectional view taken along the line VII-VII shown in FIG. 6. The gain waveguide 17 includes an n-type cladding layer 61, a lower optical guiding layer 63, the active layer 65a with the MQW structure, an upper optical guiding layer 67a, a p-type cladding layer 69 and a contact layer 71a. These layers are grown on the substrate 33 in this order. On the contact layer 71a is provided with an electrode 25.

The optical reflector 13 includes the n-type cladding layer 61, the lower optical guiding layer 63, a waveguide core layer 65b, the upper optical guiding layer 67b, an optical grating 68, the p-type cladding layer 69, and contact layers 71b that include several portions, 711b, 712b and 713b, isolated from each other and corresponding to respective optical gratings. On the contact layer 71b is formed with a plurality of electrodes 23. The optical grating 68 includes a corrugating structure formed on the optical guiding layer 67b and buried with the p-type cladding layer 69.

The phase adjuster 29 includes the n-type cladding layer 61, the lower optical guiding layer 63, the waveguide core 65c, the upper optical guiding layer 67c, the p-type cladding layer 69 and the contact layer 71c. These layers are also formed on the substrate 33 in this order. On the contact layer 71c is formed with an electrode 30.

The ring resonator 19 includes the n-type cladding layer 61, the lower optical guiding layer 63, the waveguide core 65c, the upper optical guiding layer 67c, the p-type cladding layer 69 and the contact layer 71c. These layers are also formed on the substrate 33 in this order. On the contact layer 71c is formed with an electrode 31.

The optical functioning device 53 includes the n-type cladding layer 61, the lower optical guiding layer 63, the active layer 65d with the MQW structure 59, the upper optical guiding layer 67d, the p-type cladding layer 69 and the contact layer 71d. These layers are formed on the substrate 33 in this order. On the contact layer 71d is formed with an electrode 54.

The waveguide 75 includes the n-type cladding layer 61, the lower optical guiding layer 63, the waveguide core 65c, the upper optical guiding layer 67c and the p-type cladding layer 69. These layers are also formed on the substrate 33 in this order.

Two cladding layers, 61 and 69, may confine the light vertically, while, the striped waveguide structure and the burying layer 73 that buries this striped waveguide may confine the light horizontally.

One specific example of respective layers is shown below, that is, the MQW structure 59 of the active layer 65a in the gain waveguide 17 may be a combination of GaInAsP (well layer)/GaInAsP (barrier layer) that shows an optical gain in a wavelength range from 1.25 to 1.65 μm. The guiding layers, 63 and 67a, may be GaInAsP with a band gap wavelength shorter than that of the MQW structure 59 described above, the n-type and the p-type cladding layers, 61 and 69, may be InP. The contact layer 71a may be a heavily doped GaInAs, while, the burying layer 73 may be a semi-insulating InP.

The active layer 65a in the gain waveguide 17 may have the MQW structure 59 that includes a plurality of well layers each having band gap energy different from each other and a plurality of barrier layers each put between well layers. The well layers with different band gap energy may expand the gain bandwidth of the active layer where the device is able to oscillate in the laser mode. Thus, a wider wavelength range of the laser emission may be realized. Methods to vary the band gap energy of the well layers are to form well layers with different thicknesses, to vary the composition of respective well layers, and/or to combine these two methods.

Referring to FIG. 6 again, the light-emitting device 51 further includes the waveguides, 81 and 83, made of semiconductor material. One waveguides 81 provides an end 81a, the other end 81b and a coupling portion 81c between the ends, 81a and 81b. The end 81a optically couples with the reflective end 15. The coupling portion 81c optically couples with the ring resonator 19. The semiconductor waveguide 81 further provides a bent portion 81d between the end 81a and the coupling portion 81c. The other waveguide 83 includes the end 83a, the other end 83b and the coupling portion 83c. One ends 83a optically couples with the optical reflector 13, while, the coupling portion couples with the ring resonator 19. These two waveguides, 81 and 83, provide the stacked structure 75 shown in FIG. 7. The reflective end 15 provides the high-reflection (HR) coating 77 in the end 51a.

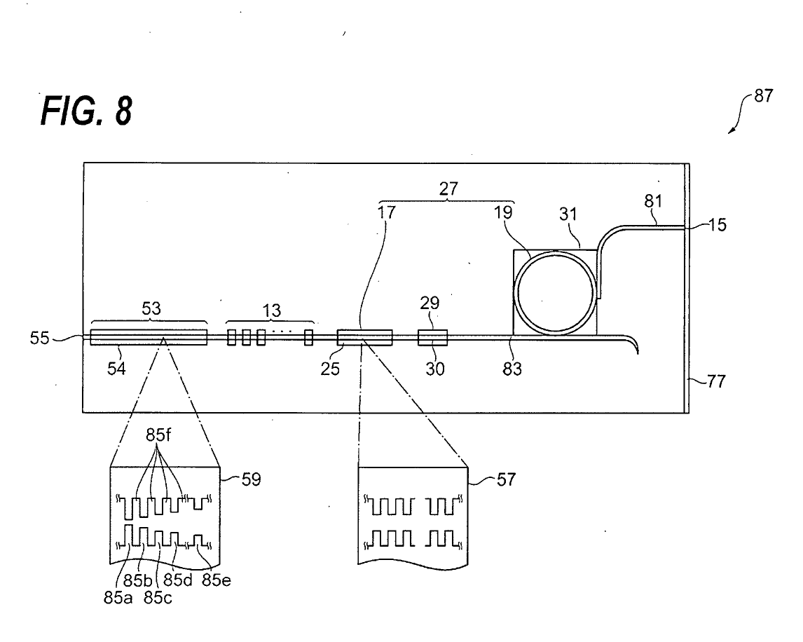

FIG. 8 schematically illustrates still another modification of the light-emitting device according to an embodiment of the invention. The light-emitting device 87 includes, as an optical functioning device 53, an optical amplifier to amplify the light. This optical amplifier 53 includes a semiconductor optical amplifier with an active layer 59 comprising of well layers, 85a to 85e, with the band gap energy different from each other, and barrier layers 85f put between well layers, 85a to 85e.

The grating segments, 21a to 21i, of the optical reflector 13 of the device 87 each shows specific reflection spectrum, 20a to 20i, such as shown in FIG. 2A. The maximum in respective reflection spectra, 20a to 20i, may be strengthened responding to the electrical bias applied to the electrodes, 23a to 23i, compared to a case where the grating receives no bias, as shown in FIG. 2B. Thus, the optical amplifier 53 in FIG. 8 is preferable to have an enough gain in the gain bandwidth wider than the full width W₀ of the composite spectrum 20 that comprises the reflections spectra, 20a to 20i, of respective grating segments, 21a to 21i.

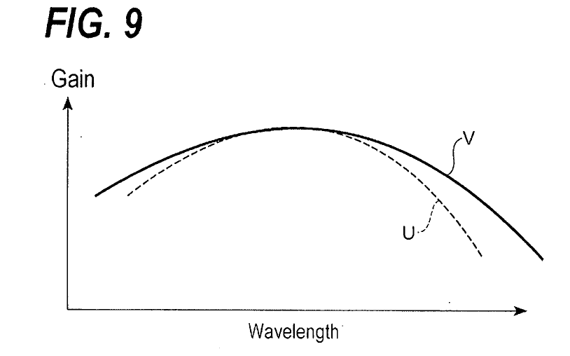

Because the active layer 59 shown in FIG. 9 provides well layers with band gap energy different from each other, the gain bandwidth of the amplifier 53 may be widened as shown in FIG. 9. The gain spectrum V of the optical amplifier 53 having the MQW structure described above may be widened in the gain bandwidth thereof compared to the spectrum U for the ordinal MQW structure where the well layers have the same structure, namely, the same band gap energy. Such a widened gain bandwidth as shown in FIG. 9 may be obtained by, as already explained, stacking well layers with different band gap energy. Such well layers may be formed by varying the thicknesses of respective well layers, by varying the compositions thereof, or by combining these two methods.

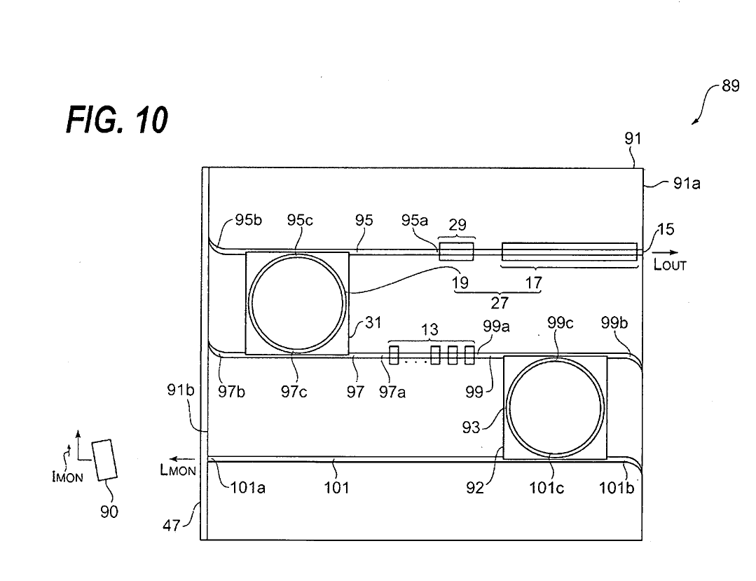

FIG. 10 schematically illustrates a light source with the function of the tunable emission wavelength, where the light source includes the semiconductor light-emitting device according to the present embodiment. The light source 89 includes the light-emitting device 91 and a light monitor 90 that generates a monitoring bias Iₘₒₙ by receiving the optical output from the semiconductor light-emitting device 91. The light monitor 90 may be a photodiode.

The semiconductor light-emitting device 91 provides the optical reflector 13, the reflective end 15, the gain waveguide 17 and the ring resonator 19. The light-emitting device 91 may further provide an optical filter as an optical functional device. An additional ring resonator 93 put outside of the laser cavity and optically coupled with the optical reflector 13 may operate as the optical filter. This ring resonator 93 comprises an optical semiconductor waveguide in a closed loop and, if necessary, may provide an electrode 92 to vary the transmission spectrum of the ring resonator 93.

The end 91a of the light-emitting device 91 is the reflective end 15 to form the laser cavity. The semiconductor light-emitting device 91 integrates the optical reflector 13, the reflective end 15, the gain waveguide 17, the ring resonator 19, the phase adjuster 29 and the other ring resonator 93 on the semiconductor substrate. The light-emitting device 91 emits light L_{OUT} from the reflective end 15. The light monitor 90 receives light L_{MON} from the optical reflector 13 via the other ring resonator 93.

The light-emitting device 91 includes several waveguides, 95, 97, 99 and 101. The first waveguide 97 optically couples one of the ring resonator 31 and the optical reflector 13 with the other, and provides an end 97a coupled with the optical reflector 13, the other end 97b and the coupling portion 97c put between these ends, 97a and 97b, and optically coupled with the ring resonator 31.

The second waveguide 99 optically couples one of the optical reflector 13 and the ring resonator 93 with the other, and provides an end 99a coupled with the optical reflector 13, the other end 99b and the coupling portion 99c optically coupled with the ring resonator 93 put between the ends, 99a and 99b.

The third waveguide 95 optically couples one of the ring resonator 19 and the ring resonator 31 with the other, and provides an end 95a optically coupled with the gain waveguide 17, the other end 95b and the coupling portion 95c, put between the ends, 95a and 95b, optically coupled with the ring resonator 19.

The fourth waveguide 101 guides the monitored light output from the ring resonator 93 to the end 91b of the light-emitting device 91 for outputting the monitored light. The fourth waveguide 101 provides an end 101a optically coupled with the end 91b, the other end 101b and the coupling portion 101c, put between the ends, 101a and 101b, and optically coupled with the ring resonator 93. The other ends, 95b to 101b of these waveguides, 95 to 101, provide a portion bent toward the end, 91a or 91b, which substantially realizes an anti-reflective end.

The ring resonator 93 has a transmission spectrum having a plurality of transmission maxima defined by the FSR. The wavelength of the laser emission is determined by the reflection spectrum of the optical reflector 13 and one of transmission maxima of the ring resonator. While, the light monitor 90 receives this laser emission L_{MON} filtered by the ring resonator 93. Setting one of transmission maxima of the ring resonator 93 equal to the emission wavelength of the light-emitting device 91, the fluctuation in the wavelength of the laser emission may be detected as the output optical power of the monitored light L_{MON}, which is reflected in the current I_{MON} from the light monitor 90. Accordingly, it is able to lock the emission wavelength of the laser light L_{OUT} by feed-backing the current I_{MON} to the electrical bias applied to the optical reflector 13.

### Second Embodiment

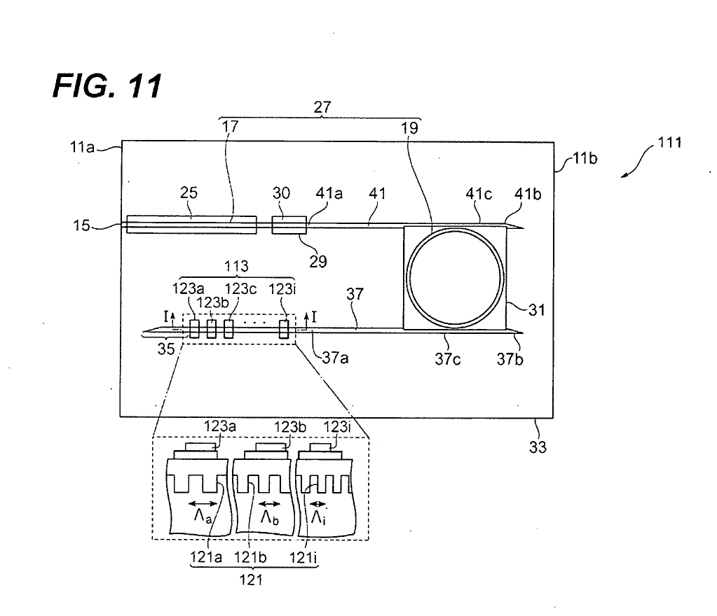

FIG. 11 illustrates a light-emitting device according to the second embodiment of the present invention. The light-emitting device 111 of the present embodiment provides, on the semiconductor substrate, an optical reflector 113, a reflective end 15, a gain waveguide 17 and a ring resonator 19. The elements without the optical reflector 113 have the same configurations with those of the first embodiment. The optical reflector 113 includes a chirped grating 121 and a plurality of electrodes, 123a, 123b, 123c, and 123i. FIG. 11 includes a sectional view that schematically illustrates the chirped grating 121 taken along the ling I-I.

The electrodes, 123a to 123i, are arranged along the primary axis of the chirped grating 121. The chirped grating 121 has a characteristic that the period of the refractive index linearly varies depending on the position. For instance, the chirped grating 121 includes a grating segment 121a with a period of the refractive index of Λₐ, a grating segment 121b with a period of Λ_{b}(Λ_{b}<Λₐ), and a grating segment 121i with a period Λᵢ(Λᵢ<Λ_{b}). For example, assuming the emission wavelength of the device is applicable to the conventional band (C-band) from =1.53 μm to λₑ=1.56 μm, the minimum period in the chirped grating 121 becomes shorter than λₛ/(2×nₛ), while the maximum period becomes longer than λₑ/(2×nₑ), where nₛ and nₑ are effective refractive indices at the wavelengths of λₛ and λₑ, respectively.

By applying the electrical bias to one of or some of electrodes, 123a to 123i, each corresponding to a grating segment, 121a to 121i, of the chirped gratings 121, which modifies the reflection spectrum of the optical reflector 123. Thus, the light-emitting device 111 may select one of the transmission peaks of the ring resonator 19 by the optical reflector 123 without using the vernier effect. Because the light-emitting device 111 does not provide the sampled grating or the super structured grating, the unevenness of the peak magnitude in the reflection spectrum of the optical reflector 123 may not appear.

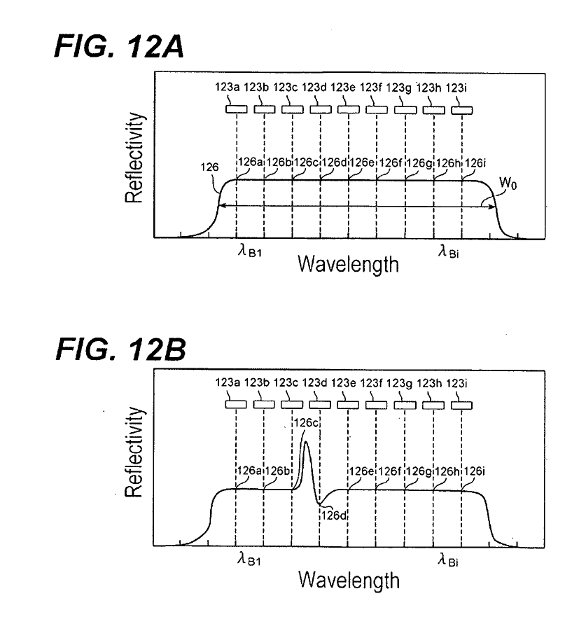

FIGS. 12A and 12B illustrate the reflection spectrum of the optical reflector 123. The wavelength range where the laser emission is obtainable is, for instance, from λ_{B1} to λ_{Bi}. The optical reflector 113 in this example includes the chirped grating 121 and nine electrodes, 123a to 123i, arrange along the waveguide. Each electrode corresponds to grating segments, 121a to 121i, of the chirped grating 121, respectively. Each grating segment, 121a to 121i, provides the period of the refractive index that shows one of Bragg diffraction wavelengths.

Thus, each portion of the chirped grating shows reflection spectra, 126a to 126i, as those shown in FIG. 12A when the electrodes, 123a to 123i, receives no bias. Applying a bias current to a specific electrode, the electrode 123d in the example shown in FIG. 12B, the reflectivity is decreased at the diffractive wavelength 126d corresponding to a portion of the chirped grating 121 where the electrode 123d is formed, while, the reflectivity is enhanced in a shorter wavelength by the superposition of the original reflectivity attributed to the portion of the grating, which is shown in FIG. 12A, with the blue shifted reflectivity attributed to the adjacent portion of the grating. Accordingly, selecting the electrode where the electrical bias is applied to, the reflection spectrum of the specific wavelength may be enhanced. The electrode 123a is formed apart from the edge of the chirped grating 121, while the other electrode 123i is formed apart from the other edge of the grating 121.

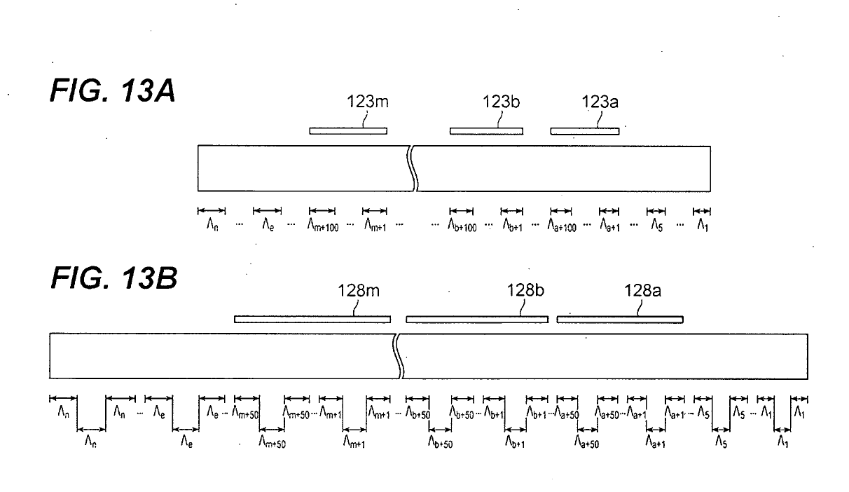

FIG. 13A illustrates a cross section of an exemplary chirped grating with electrodes. The period of the refractive index linearly increases from one end to the other as expressed by a relation of Λ₁<Λ₂<Λ₃< . . . <Λₙ. The m counts of electrodes, 123a to 123m, are arranged along the grating. For instance, the electrode 123a covers about a hundred periods of the grating whose periods are from Λₐ₊₁ to Λₐ₊₁₀₀, while, an electrode 123m covers another about one hundred of the grating whose periods are from Λₘ₊₁ to Λₘ₊₁₀₀. The portion of the grating for the period Λₐ₊₁₀₀ and that for the period Λ_{b+100} are unnecessary to be side by side. Moreover, the term of about one hundred of periods means that the position of the electrode may be off by a few periods with respect to the portion of the grating corresponding to the electrode. Thus, the chirped grating may reduce the influence of the miss-alignment of the electrode with respect to the grating on the reflection spectrum.

FIG. 13B is a cross section of another example of the chirped grating. In this grating, the period of the refractive index monotonically increases form the left to the right as Λ₁<Λ₂<Λ₃< . . . <Λₙ with groups of periods. For instance, the first three corrugations have the period of Λ₁, and subsequent three corrugations have the period of Λ₂. Thus, the period of the refractive index in the grating monotonically varies every three periods in step-like. The m count of electrodes, 128a to 128m, are arranged on the grating, namely, the first electrode 128a is provided on a portion whose periods are from Λₐ₊₁ to Λₐ₊₅₀, the next electrode 128b is on another portion including 150 periods from Λ_{b+1} to Λ_{b+50}. The portion of the grating with the period Λₐ₊₅₀ and that with the period Λ_{b+1} are unnecessary to be side by side. Moreover, the term of the portion of the grating means that the position of the electrode may be off by a few periods of the corrugation with respect to the grating corresponding to the electrode. Such a grating with the step-like increment of the period may be facilitated in the production.

The function of the present light-emitting device to tune the emission wavelength will be described below. First, by applying a bias current to an electrode or bias currents to electrodes, the reflectivity of the optical reflector may be enhanced in a wavelength range including a prescribed emission wavelength. The present light-emitting device provides the FSR of the ring resonator substantially equivalent to the wavelength range where the reflectivity of the reflector is enhanced. In other words, the wavelength range where the reflectivity is enhanced involves at least one transmission maximum of the ring resonator, which enables the light-emitting device to emit the laser light. The emission wavelength in this state may be determined by a condition where a product of the reflectivity with the transmission maxima becomes the maximum.

Second, the phase adjuster adjusts the phase of the laser emission by supplying a bias current thereto so as to maximize the intensity of the laser emission. Third, the ring resonator sets the transmission maximum, around which the laser emission is occurred, to the target wavelength as externally monitoring the emission wavelength of the device. Subsequently, the second and the third steps described above are iterated until the laser emission becomes stable at the target wavelength.

When the target wavelength becomes out of the wavelength range where the reflectivity of the optical reflector is enhanced, another electrode or a different combination of electrodes may be selected and the second and the third steps are iterated until the laser emission at the target wavelength may be stably obtained.

It is preferable that the reflection spectrum modified by the injection current or the applied bias voltage may involve at least one transmission maxima of the ring resonator. Too many transmission maxima within the modified reflection spectrum may degrade the single mode quality of the emission spectrum. For instance, one to five transmission maxima may be within the modified reflection spectrum.

The light-emitting device of the present invention may show relatively high optical output because the device does not emit light through the optical reflector. Moreover, the device of the invention may show smaller threshold current and higher slop efficiency compared to the conventional tunable device because the optical cavity includes only one ring resonator, which reduces the optical loss within the cavity.

The optical reflector with the chirped grating shows a flat reflection spectrum without any perturbation to the refractive index by the injection current or the applied bias voltage. Accordingly, the performance of the ring resonator, such as the free spectral range and the magnitude of the transmission maxima, may be easily evaluated by observing the stimulated emission or the spontaneous emission from the device without the perturbation on the optical reflector.

Moreover, the present device provides no reflecting mirror in the end of the cavity, which enables to integrate all optical elements such as the optical modulator, the optical amplifier and the like on the common semiconductor substrate, which also enables the device to be miniaturized. The optical modulator may be a Mach-Zender type modulator or a semiconductor modulator.

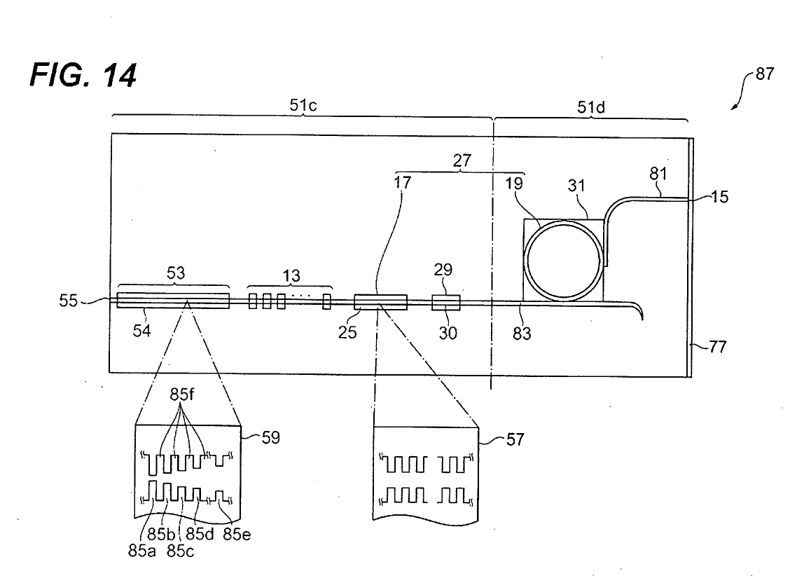

Or, the light-emitting device of the invention may provide two units, one of which includes the ring resonator and the other of which includes rest elements, as shown in FIG. 14. The first unit 51d provides the ring resonator 31 and waveguides, 81 and 83, on a silica glass. It may be simple to form the ring resonator on the silica glass compared to a case where the resonator is formed on a semiconductor substrate. Moreover, the resonator on the silica glass shows stable characteristics against temperatures. The waveguide 83 may optically couple with a waveguide on the second unit 51c directly with the butt-joint or indirectly via a lens. The adjustment of the transmission maxima or the free spectral range of the ring resonator may be carried out by heating the ring resonator directly with a heater formed adjacent to the resonator.

While the invention has been described with reference to illustrative embodiments, it is to be understood that such embodiments are merely illustrative and not restrictive, and it would be apparent that the same may be varied in many ways by one with ordinary skill in the art. Accordingly, such modifications are deemed to lie within the principle and scope of the invention as expressed in the following claims.

I claim:

1. A light-emitting device capable of tuning an emission wavelength, comprising:
an optical cavity defined by a reflective end and an optical reflector, said optical reflector including an optical grating with a plurality of electrodes, said optical reflector showing a variable reflection spectrum with an enhanced reflectivity region by applying bias current to specific electrodes among said plurality of electrodes to change a refractive index of a portion of said optical grating covered by said specific electrodes;
a gain waveguide provided within said optical cavity, said gain waveguide having an optical gain by injecting carriers therein; and
a ring resonator provided within said optical cavity, said ring resonator having a transmission spectrum with a plurality of transmission maxima,
wherein said emission wavelength is determined by an overlap of said transmission maxima in said transmission spectrum of said ring resonator with said enhanced reflectivity region in said reflection spectrum of said optical reflector.

2. The light-emitting device according to claim 1,
wherein said optical grating includes a plurality of grating sections each having a specific period of refractive index, one of said electrodes corresponding to one of said grating sections.

3. The light-emitting device according to claim 2,
wherein said specific period of refractive index of respective grating sections monotonically change from an end of said optical grating to another end of said optical grating.

4. The light-emitting device according to claim 1,
wherein said optical grating includes a chirped grating with periods of refractive index linearly changing from an end of said optical grating to another end of said optical grating, said specific electrodes changing refractive index of said portion of said chirped grating covered by said specific electrodes.

5. The light-emitting device according to claim 1,
wherein said reflection spectrum of said optical reflector includes at least one of said transmission maxima in said transmission spectrum of said ring resonator.

6. The light-emitting device according to claim 5,
wherein said reflection spectrum of said optical reflector includes not more than five transmission maxima in said transmission spectrum of said ring resonator.

7. The light-emitting device according to claim 7,
further including a phase adjuster in said optical cavity, said phase adjuster providing an electrode to change refractive index in a portion covered by said electrode of the said phase adjuster.

8. The light-emitting device according to claim 1,
further including an optical modulator outside of said optical cavity, said optical modulator modulates an emission output from said optical cavity.

9. The light-emitting device according to claim 1,
further including an optical amplifier outside of said optical cavity, said optical amplifier amplifies an emission output from said optical cavity.

10. The light-emitting device according to claim 1,
wherein said optical reflector, said ring resonator and said gain waveguide are integrally formed on a semiconductor substrate.

11. The light-emitting device according to claim 1,
wherein said ring resonator is formed on a silica substrate, and said optical reflector and said gain waveguide are formed on a semiconductor substrate.

12. The light-emitting device according to claim 11,
wherein said silica substrate further provides a waveguide optically coupled with said ring resonator, said waveguide on said silica substrate optically coupling with said gain waveguide on said semiconductor substrate by a butt-joint technique.

13. The light-emitting device according to claim 11,
wherein said silica substrate further provides a waveguide optically couples with said ring resonator, said waveguide on said silica substrate optically coupling with said gain wave guide on said semiconductor substrate through a lens.

14. The light-emitting device according to claim 1,
wherein said gain waveguide provides said lower cladding layer, said lower guiding layer, an active layer with a multiple quantum well structure, a first upper guiding layer, and a first upper cladding layer,
wherein said ring resonator provides said lower cladding layer, said lower guiding layer, a waveguide core, said first upper guiding layer, and said first upper cladding layer,
wherein said optical reflector provides said lower cladding layer, said lower guiding layer, a waveguide core, second upper guiding layer, and second upper cladding layer,
wherein said multiple quantum well layer has a band gap wavelength from 1.25 μm to 1.65 μm and includes a plurality of well layers made of GaInAsP and a plurality of barrier layers made of GaInAsP with a composition different from said GaInAsP of said well layers, and
wherein said waveguide core is made of GaInAsP with a band gap wavelength shorter than said band gap wavelength of said active layer.

15. The light-emitting device according to claim 14,
wherein one of said well layers has a band gap wavelength different from the other of well layers.

16. The light-emitting device according to claim 14,
wherein one of said well layers has a thickness different from thicknesses of the other of well layers.

17. The light-emitting device according to claim 1,
wherein an output emission is provided from said reflective end of said optical cavity.
